(19) United States
(12) Patent Application Publication
(10) Pub. No.: US 2007/0010407 A1
(43) Pub. Date: Jan. 11, 2007

(54) Scent composites

(76) Inventors: Wilfried Rahse, Dusseldorf (DE); Peter Victor, Dusseldort (DE)

Correspondence Address: PAUL & PAUL, 2900 TWO THOUSAND MARKET STREET, PHILADELPHIA, PA, 19103, US

(21) Appl. No.: 11/450,634

(22) Filed: Jun. 9, 2006

Related U.S. Application Data
(63) Continuation of application No. PCT/EP04/12322, filed on Oct. 30, 2004.

(30) Foreign Application Priority Data
Dec. 10, 2003 (DE) 103 57 676.2

(51) Int. Cl. C11D 3/50; C11D 9/44

(52) U.S. Cl. 510/102

(57) ABSTRACT

The invention relates to scent composites comprising at least one perfume oil and at least one additive having a melting or flow point of 20° C.-100° C. Said composites are highly viscous or solid at temperatures of up to 18° C. and are converted into a liquid melt state, substantially without decomposition, at temperatures of not more than 110° C. The invention also relates to a method for the solidification of perfume oils and to a method for long-lasting perfuming of the surfaces of substrates. The invention further relates to the use of said composites and detergents, cleaning and textile post-treatment agents containing said scent composites.

### CROSS-REFERENCE TO RELATED APPLICATIONS

This application is a continuation under 35 U.S.C. §365(c) and 35 U.S.C. §120 of International Application No. PCT/EP2004/012322, filed Oct. 30, 2004. This application also claims priority under 35 U.S.C. §119 of German Patent Application No. DE 103 57 676.2, filed Dec. 10, 2003. Both the International Application and the German Application are incorporated by reference in their entireties.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

(1) Field of the Invention

The invention relates to scent composites that are highly viscous or solid at temperatures up to 18° C. and comprise at least one perfume or a perfume oil and at least one additive that has a melting point or pour point in the range 20 to 100° C., wherein the scent composite as such assumes a molten liquid state at temperatures below 110° C., substantially without decomposition. The invention further relates to a process for the manufacture of such scent composites and their use for perfuming rooms, for example.

Everyday life would be unthinkable without perfumes, aromas and perfume oils. From time immemorial they have played an important role in human culture, first in cultic usages, a little later also in beauty care. In our time as well, they have a prominent and ever increasing significance, e.g., in the field of product perfuming, in the field of personal care products or in the field of detergents and cleansers.

The volatility of a perfume is crucial for its perceptibility, whereby in addition to the nature of the functional groups and the structure of the chemical compound, the molecular weight also plays a role. Thus, the majority of perfumes has molecular weights up to 200 daltons, and molecular weights of 300 daltons and above are quite an exception. Due to the different volatilities of perfumes, the smell of a perfume or fragrance composed of a plurality of odoriferous substances changes during evaporation, the impressions of odor being subdivided into the “top note,” “middle note” or “body” and “end note” or “dry out.” As the perception of smell depends to a large extent on the intensity of the odor, the top note of a perfume or fragrance is naturally determined by highly volatile compounds, while the end note consists to a large extent of less volatile, i.e., tenacious odoriferous substances. In the composition of perfumes, higher volatile odoriferous substances can be bound, for example, onto particular fixatives, whereby their rapid evaporation is impeded.

A fundamental method for the controlled release of fragrances, e.g., from detergents, is by their direct addition to application formulations. The disadvantage of this method is the immediate release of the fragrance from the formulation, leading to a short-term fragrance effect and thus a greatly reduced shelf life of the formulation. In addition, the low chemical stability towards atmospheric oxygen, shown by numerous fragrances, particularly aldehydes and alcohols, was observed. Attempts to encapsulate such substances or to incorporate them in cyclodextrins showed little success or were uneconomic due to the high raw material costs.

(2) Description of Related Art, Including Information Disclosed Under 37 C.F.R. §§1.97 and 1.98.

The methods of immobilization by chemical derivation of the fragrances proved to be advantageous for generating a long-lasting fragrance effect. Thus, WO-A-95/04809 teaches the slow cleavage of esters of fragrance alcohols by lipases, so as to produce a long-lasting fragrance. In WO-A-97/3067 and EP-A-816322, binding to sulfonates, sulfates and phosphates was carried out and resulted in similar effects. Further possibilities for the controlled slow release of fragrance alcohols are betaine esters, as shown in EP-A-0799885, α-tertiary hydrocarbon esters in WO-A-98/07810, β-ketoesters in WO-A-98/07813 or linear or cyclic acetals. The subject of WO-A-94/06441 is the acid hydrolysis of acetals and orthoesters that are based on aldehydes/ketones or alcohols with fragrant properties.

However, the chemical derivation of fragrances is often associated with high costs or engineering complexities and at the end of the day may lead to an alienation of the fragrance impression. Consequently, there remains an undiminished demand for fragrances with a long-lasting fragrance effect.

The prior art includes additional proposals to satisfy this requirement. Loading silica particles with fragrances and their use in washing powders are described in EP-A-0820762. EP-A-0281034 teaches the incorporation of fragrance compositions into inorganic polymer matrices, wherein the respective polymer is crosslinked. In both these patent documents, perfume is essentially absorbed in carrier materials or fixed onto a carrier.

The International Applications WO 99/21953 and WO 01/16280 deal, in a similar context, with processes for manufacturing fragrant molded bodies, particularly fragrant beads. For this, solid premixes of 65 to 95 wt. % carrier(s), 5 to 25 wt. % perfume and up to 10 wt. % auxiliaries are subjected to a granulation or pressure agglomeration. Now these processes are imperatively reliant on high proportions of carrier(s), with the result that a maximum perfume content of only 25 wt. % can be attained. This conformation of ingredients is not desirable for all application fields, for example, not for those in which higher proportions of perfume are required on grounds of odor intensity.

### BRIEF SUMMARY OF THE INVENTION

The object of the present described invention is accordingly the provision of alternative compositions for controlled and regular release of a fragrance or a mixture of fragrances over a long time period (slow release; long lasting).

This object is achieved by scent composites that are highly viscous or solid at temperatures up to at least 18° C. and which comprise at least one perfume oil and at least one additive that has a melting point or pour point in the range 20° C. to 100° C., wherein the scent composite assumes a molten liquid state substantially without decomposition at temperatures below 110° C., preferably below 100° C., advantageously below 90° C., more advantageously below 80° C., in particular, below 70° C.

The advantage associated with the scent composite assuming a molten liquid state substantially without decomposition at temperatures below 110° C., preferably below 100° C., advantageously below 90° C., more advantageously below 80° C., in particular, below 70° C., is due to the fact that the comparatively mild melting points ensure that as the scent composite melts, which may possibly be required, the perfume oil constituents are not substantially driven out of it. One can immediately understand for example, that a fragrant molded body, that first melts at 250° C., for example, can if necessary be converted into a liquid melt state, but at such temperatures, the perfume oil ingredients present in the object would be driven out very quickly, for example, by evaporation of these ingredients.

### BRIEF DESCRIPTION OF THE SEVERAL VIEWS OF THE DRAWING(S)

Not Applicable

### DETAILED DESCRIPTION OF THE INVENTION

The term “substantially without decomposition” allows for the fact that some materials or compounds or substances and therefore also objects that contain these substances, can decompose as a result of the input of thermal energy. This means that the material in question is changed in its structure in such a way that it is converted into a form that is no longer suitable for its original purpose. As an example, one can cite crosslinked polymers. These cannot be transformed into a flowable form without their suffering irreversible changes. Unlike these, the inventive scent composites are characterized in that they transform into a liquid melt state substantially without decomposition. This means that under the specific burden of temperature required to convert them into the liquid melt state, they do not undergo any major degradation, such that an inventive composite, even after its conversion to a flowable state and its subsequent reconversion back into the solid state, can be used again for its original purpose without problem. The opposite of this is an object, for example, which undergoes decompositions during conversion into the liquid melt state, such that after its reconversion back to the solid state, the object markedly differs from its initial state, e.g., in regard to its optical appearance, its surface feel, its smell or in other aspects.

In practice, “substantially without decomposition” means that the transition of the scent composite into the liquid melt state proceeds in such a way that the weight loss of the scent composite, resulting from the passage from the solid state, liquid state and back to the solid state, is preferably maximum 10 wt. %, advantageously maximum 5 wt. %, more advantageously maximum 1 wt. %, even more advantageously maximum 0.5 wt. %, especially no weight loss occurs (wt. % based on the total composition), i.e., the scent composite can be liquefied and then converted back to the solid state, without it suffering any weight loss.

The term “scent composite” (“composite” is derived from the Latin verb “componere”: to compose) reveals that the composition is composed of at least two components, namely at least one perfume oil and at least one additive that has a melting point or pour point in the range 20 to 100° C., wherein the perfume oil may also be a harmonious mixture of a plurality of odoriferous substances.

In the context of this invention, the term perfume oil is widely encompassing, as it includes, here, all such single substances or mixtures of substances that trigger a preferably pleasant sensation of smell in humans and hence are suitable for perfuming or providing a scent, for example, to objects such as technical and sanitary articles, soaps, cosmetics, (body care products) and the like, and are employed in many applications. In the scope of this invention, the notion of perfume oil consequently includes essentially all ethereal oils, odoriferous substances and aromatic substances, singly and in mixtures of two up to 100 or more different constituents. However, essences and aromas or aromatic substances or their mixtures are expressly included here in the notion of perfume oils. In addition, the pheromones are also explicitly included in the term perfume oil, even though, strictly speaking, they are not odoriferous substances. Naturally, the notion of perfume oils particularly means the classical perfume oils, i.e., those that are obtained by crushing, for example, fruit husks, by extraction of resins from rosins, balms, lichen and mosses, by extraction of (flower) fragrances by means of super critical gases (e.g., CO₂) or by steam distillation of previously prepared chopped up parts of plants, such as e.g., oil of rose.

Individual odoriferous compounds, for example, the synthetic products of the ester, ether, aldehyde, ketone, alcohol and hydrocarbon type can be used, for example, as perfume oils. Odoriferous compounds of the ester type are, for example, benzyl acetate, phenoxyethyl isobutyrate, p-tert.-butylcyclohexyl acetate, linalyl acetate, dimethylbenzyl carbinyl acetate, phenylethyl acetate, linalyl benzoate, benzyl formate, ethylmethylphenyl glycinate, allylcyclohexyl propionate, styrallyl propionate and benzyl salicylate. The ethers include, for example, benzyl ethyl ether; the aldehydes include, for example, the linear alkanals containing 8 to 18 carbon atoms, citral, citronellal, citronellyloxyacetaldehyde, cyclamen aldehyde, hydroxycitronellal, lilial and bourgeonal; the ketones include, for example, the ionones, ∝-isomethyl ionone and methyl cedryl ketone; the alcohols include anethol, citronellol, eugenol, geraniol, linalool, phenylethyl alcohol and terpineol and the hydrocarbons include, above all, the terpenes and balsam. However, mixtures of various odoriferous substances, which together produce an attractive perfume note, are preferably used.

Of course, the perfume oils can also contain natural mixtures of odoriferous substances, as are obtainable from vegetal or animal sources, for example, pine, citrus, jasmine, patchouli, rose or ylang-ylang oil. The ethereal oils of lower volatility that are mostly used as aroma components are suitable as perfume oils, e.g., oil of sage, chamomile oil, clove oil, melissa oil, mint oil, cinnamon leaf oil, lime blossom oil, juniper berry oil, vetivert oil, olibanum oil, galbanum oil and laudanum oil.

Due to the fact that the scent composites are highly viscous or solid at temperatures up to 18° C., a long-lasting fragrant impression can be obtained because the diffusion coefficient of the scent composite is significantly lower than that of a normal liquid perfume oil. Without being bound by any theory, the applicant proceeds on the assumption that the diffusion coefficient in the scent composite is about at least two orders of magnitude less than in the liquid perfume oil.

The fragrances are therefore only released very slowly—although continuously from the scent composite, and thus a retarded fragrance effect is produced in comparison with the original perfume oil.

A scent composite is considered to be highly viscous when the Brookfield viscosity at 20° C. exceeds a value of 2,500 mPas, advantageously 5,000 mPas, particularly 7,500 mPas, preferably 10,000 mPas and particularly preferably 25,000 mPas (viscosity measurement in a Brookfield Viscosimeter model DV II at 20 rpm with spindle 3).

This very slow, but continuous fragrance release is advantageous in many respects. In addition, there is a particular advantage in that there are great numbers of chemical compounds whose odors are detected by humans even far below the analytical detection limits i.e., in extreme dilution. The scent composite now enables the possibility of also deploying or providing these extremely intense smelling compounds in an easily manageable to high concentration. Because these compounds possess an otherwise overpowering fragrance intensity, up to now it was only possible to manage these compounds at the highest dilution in order to avoid an overpowering odor. The scent composite now ideally enables these fragrant intensive compounds to be slowly and continuously released. However, there are additional advantages in comparison with the above-mentioned prior art, which to some extent, also enables a slow and continuous fragrance release. The above-mentioned prior art essentially offers the concept of absorbing perfume in carrier materials or fixing the perfume onto a carrier. The disadvantage that results from this is obvious. A fragrant molded article, made for example, of silica and perfume or of a crosslinked inorganic polymer matrix and perfume, has more or less an irreversible shape or form and cannot tolerate being liquefied without serious losses in quality. On the other hand, an inventive composition can be comfortably deformed as it is converted into a liquid melt state at temperatures below 110° C. substantially without decomposition. In doing so, the inventive scent composite suffers no serious losses in quality, in regard to the scent character, for example. For compositions according to the prior art, on the other hand, there is very limited freedom concerning a subsequent form or shape change, as the structures made of crosslinked inorganic polymer matrix and perfume, for example, decompose at increased temperatures as a result of the crosslinking of the polymer. Compositions in which the perfume is absorbed in the silica can only be liquefied in theory. However, the resulting temperatures required or reached by silicate melts, destroy any perfume oil. A further advantage of the inventive composition, specifically over the fragrance beads in accordance with WO 99/21953 and WO 01/16280, is that all the fragrance beads can only carry a perfume fraction of maximum 25 wt. %. This is a significant restriction that does not apply at all to the inventive compositions. The amounts of perfume in the compositions can be adjusted without problem to significantly more than 25 wt. % as will be demonstrated further below.

A further advantage of the invention is in the markedly improved shelf stability of the scent composites compared with that of the usual perfume oils. Firstly, the scent composites by nature do not volatilize out as rapidly as the usual perfume oils, and secondly the scent composites are significantly more oxygen-stable. In certain cases this may also be the case for scent composites according to the prior art. However, the combination of shelf stability and reversible shape forming must be considered here. For example, it is possible to store an inventive composition in the form of a large monolithic block. When needed, any amount or portion of the block can be removed by warming the block. This concept, for example, cannot be realized with a silica particle. The scented beads according to WO 99/21953 and WO 01/16280 are unattractive for an effective storage of perfume, as at least 75 wt. % ballast, which is not perfume, is stored together with it.

The crucial advantages of the scent composites, particularly the solid scent composites, are therefore that they can be easily liquefied and subsequently resolidified, as well as being easily shaped, with the result that the scent composites can also be produced in, for example, spherical, star-shaped or rectangular form. For this, a room temperature (ca. 20-22° C.) solid scent composite, for example, is heated and converted to the liquid state, the mixture is poured into a mold of any shape and allowed to cool down. The cooled, shaped, room temperature solid scent composite is then removed. However, it is also possible that the filled mold represents the end product or the sales product.

According to a preferred embodiment, an inventive composition is characterized in that it consists of at least 20 wt. %, preferably at least 30 wt. %, advantageously at least 40 wt. %, very advantageously at least 50 wt. %, especially advantageously at least 60 wt. %, extremely advantageously at least 70 wt. %, exceedingly advantageously at least 80 wt. %, even more advantageously at least 90 wt. %, especially at least 95 wt. %, but most advantageously 100 wt. % of the components perfume oil(s) as well as additive(s) with melting points or pour points in the range 20° C. to 100° C.

Above their melting point, the additives, which have a melting point or pour point between 20° C. and 100° C., dissolve at least partially, particularly even completely in perfume oil. A further preferred development of the invention is therefore that at least the additives with melting points or pour points in the range 20° C. to 100° C. are at least partially soluble in the perfume oil, preferably essentially completely soluble in the perfume oil close to their respective pour points.

According to a further preferred embodiment, the additives with a melting point or pour point in the range 20° C. to 100° C. have an essentially neutral smell, preferably all additives have an essentially neutral smell.

In this context, an essentially neutral smell means that the fragrance of the perfume oils is not spoiled by a particularly intensive, inherent smell of the additive that is possibly offensive to the human sense of smell. Therefore, the additives should preferably not have a significant inherent smell and they should not debase the fragrance of the perfume oil.

According to a further preferred embodiment of the invention, the composition is highly viscous or especially is solid at temperatures up to 20° C., preferably up to 22° C., advantageously up to 28° C., very advantageously up to 32° C., especially advantageously up to 38° C., quite particularly advantageously up to 42° C., and exceedingly advantageously up to 48° C.

The higher the pour point of the additives, whose melting points or pour points fall in the range 20° C. to 100° C., then the higher the pour point of the composition can also be adjusted. In a further preferred embodiment of the invention, the pour point of the additives that are flowable at increased temperatures (i.e., additives, whose melting point or pour point is between 20° C. and 100° C.) or of the mixture of additives there from higher than 20° C., is preferably in the range 25 to 90° C., advantageously in the range 30 to 70° C. and particularly in the range 35 to 60° C.

The proportion of additives, whose melting point or pour point is between 20° C. and 100° C., can be used to influence not only the pour point of the composition but also control the intensity of the fragrance and the duration of the fragrance release. The greater the proportion of these additives (and optionally additional additives) with respect to the same unit mass of scent composite, generally, the lower is the fragrance intensity and hence generally, the shorter is the duration of fragrance release because strictly speaking, less perfume oil is comprised in the composite and therefore available for release.

In a further preferred embodiment of the invention, the composition comprises up to 90 wt. %, preferably 10 to 80 wt. %, however, particularly preferably less than 75 wt. %, namely advantageously 15 to 65 wt. %, very advantageously 20 to 55 wt. %, even more advantageously 28 to 50 wt. % of additives that are flowable at increased temperatures (i.e., additives, whose melting point or pour point is between 20° C. and 100° C.), based on the total composition.

Conversely, the fragrance intensity and the duration of the fragrance release are also influenced by the content of perfume oil in the scent composite. In a preferred embodiment, the inventive agent is characterized in that it comprises more than 10 wt. % of perfume oil, preferably more than 25 wt. %, advantageously 26 to 90 wt. %, very advantageously 30 to 80 wt. %, even more advantageously 40 to 75 wt. %, especially 50 to 72 wt. % of perfume oil, based on the total composition.

From application technological or production technological reasons, it may be required that the composition comprises water. For example, the additives used or the perfume oils used may comprise water. Preferably, however, the composition comprises little water. Accordingly, a preferred development of the invention states that the composition comprises less than 10 wt. %, preferably less than 5 wt. %, advantageously less than 3 wt. % of water, and in particular, is totally anhydrous.

Those materials that are intended to be present along with the perfume oil in the scent composite have, as described above, to advantageously fulfill the requirement that they have melting points or pour points in the range 20° C. to 100° C. There are a great number of substances that meet such a requirement. According to a further preferred embodiment of the invention, the substances having pour points in the temperature range 20° C. to 100° C. and comprised in the scent composite are selected from the group of fatty alcohols, fatty acids, silicone oils, paraffins, non-ionic surfactants, esterquats, natural oils, waxes and/or polyalkylene glycols, without, however, being restricted to these.

Of course, the composition can also comprise additional substances, if so desired. These solids do not usually have a melting point or pour point in the range 20 to 100° C., but rather higher than 100° C., if the solids actually have a melting point or pour point. Accordingly, in a further preferred embodiment of the invention, the inventive composition comprises solids, preferably typical solids used in detergents, wherein the proportion of solids is preferably less than 70 wt. %, advantageously less than 50 wt. %, very advantageously less than 25 wt. %, particularly less than 15 wt. %, most advantageously less than 10 wt. %, based on the total composition. According to a further preferred embodiment, these solids have a d₅₀ value of less than 0.2 mm, preferably less than 0.1 mm, in particular, less than 0.05 mm.

The d₅₀ value corresponds to the mean particle diameter. According to DIN 66160: 1992-09, this is the characteristic value for which the sum of the distribution of the particle diameters takes the value 0.5=50%. For example, the statement d₅₀=a μm means that 50 (weight)% of the particles in the product under consideration have a diameter greater than a μm and 50 (weight)% have a diameter less than a μm.

By typical solids used in detergents, is meant all solids reasonably used in connection with washing processes for washing. These are known to the person skilled in the art or can be found in the pertinent literature. Nevertheless, specific solids are used in order that the composition, according to a further preferred development, comprises ingredients selected from the group of zeolites, bentonites, silicates, phosphates, urea and/or its derivatives, sulfates, carbonates, citrates, citric acid, acetates and/or salts of anionic surfactants.

The advantage of the composition comprising such substances is in the use of the scent composites in connection with detergents and washing processes for washing, which will be discussed later. By the combined use of fine, high surface solids, the perfume oils are further adsorbed and their release is thereby further retarded.

A further subject of the invention is in the use of additives that are at least partially soluble in perfume oil and have a melting point in the range 20° C. to 100° C. for manufacturing a scent composite that is highly viscous or solid at temperatures up to 18° C. with a long-lasting fragrant action, wherein the scent composite assumes a molten liquid state at temperatures below 110° C., substantially without decomposition. Likewise, a process for solidifying perfume oil(s), in which conventional perfume oils are combined with additives that are at least partially soluble in the perfume oil and have a pour point in the range 20° C. to 100° C. represents a further subject of the invention, with the proviso that the solidified perfume oil assumes a molten liquid state at temperatures below 110° C., substantially without decomposition, and is highly viscous or solid at temperatures up to 18° C.

According to a preferred embodiment of this process,
a) one or a plurality of perfume oil(s) are blended at 20 to 22° C., with stirring, with the additives that have a pour point between 20° C. and 100° C. and subsequently
b) the mixture is heated to temperatures in the range of the pour point of the additives, preferably above the pour point, and subsequently at the increased temperature
c) optionally, further additives, particularly typical detergent additives, advantageously selected from the group of zeolites, bentonites, silicates, phosphates, urea and/or its derivatives, sulfates, carbonates, citrates, citric acid, acetates and/or salts of anionic surfactants, are suspended therein, and finally,
d) the mixture is solidified by cooling to a temperature in the region of 18 to 25° C.

According to a further preferred embodiment of the invention, the mixture is sprayed at the processing temperature, i.e., prior to cooling, prilled or made into pastilles and then, due to the cooling, transforms into the highly viscous or solid state, wherein it therefore particularly assumes the form of fine droplets, beads, prills or pastilles. These can be advantageously colored in the liquid phase at increased temperature, resulting in easily recognizable scent composites.

The advantage of producing, for example, in droplet form or bead form is that these scent composite beads, for example, can be added directly to a granular detergent without the need for additional processing steps.

If the processing temperature of the perfume oil from a given production should be very low, then according to a further preferred embodiment of the invention, a mixture of perfume oil(s) and additives is taken up in liquid carbon dioxide (CO₂), then further blended and finally atomized.

The atomization of the mixture of perfume oil(s) and additives is generally advantageous, whether carried out in liquid CO₂ or the heated, fluid mixture is atomized as such. Consequently, a further embodiment of the invention is constituted by a process for long-lasting perfuming of substrate surfaces, in which the inventive scent composite is brought beforehand into a liquid state by heating, applied, preferably by spraying, onto the substrate surface that is to be perfumed.

The advantage of this process is that a long-lasting surface perfuming of even high surface-substrates can be achieved with minor effort. The composite can be laid out, for example, as a film on the substrate surface. Cardboard surfaces, for example, can be easily and long-lastingly perfumed in this way.

Although essentially all substrate surfaces can be perfumed with the scent composite, in a preferred embodiment, the substrate surfaces are solid detergents or cleansers (ingredients).

The advantage of perfuming the solid detergent or cleanser (ingredients) is that a consumer need can be satisfied by simple compositions. The consumer wants both the detergent itself, the suds and the washed articles to smell as good and as long as possible. There are several concepts for satisfying these requirements. By perfuming the substrate surfaces of solid detergent or cleanser (ingredients), a long lasting perfuming of the detergent per se is achieved in a simple way. The retardant effect of the scent composite on the surface of the solid detergent or cleanser (ingredients), also enables a very large part of the releasable scent to be released primarily in the washing process and not evaporated before that, and therefore the suds also have a pleasant smell.

Not only is there the possibility of providing a long-lasting perfuming to surfaces in the detergent field, e.g., detergent packages or solid detergent ingredients, but also the scent composites can be implemented directly into the detergent or cleanser. Thus, detergents or cleansers, advantageously in non-liquid form, which comprise preferably bead shaped and particularly colored inventive scent composites, illustrate a further subject of the invention.

Such detergents or cleansers can comprise, in addition to the inventive scent composites, all the ingredients that are usually comprised in detergents or cleansers. These ingredients are well known to each person skilled in the art of detergents or cleansers and so a listing of them here would be superfluous. In the context of this application, the term detergent also expressly means wash conditioners and rinse agents. Appropriate wash conditioners or rinse agents can accordingly comprise, in addition to the inventive scent composites, the usual ingredients specific to wash conditioners and rinse agents, which are well known to the person skilled in the art. A list of these ingredients, which are already well known to the person skilled in the art, can be dispensed with.

The previously mentioned scent composites that comprise the usual detergent solids, such as, e.g., bentonite, are particularly advantageous in this total composition.

In this manner, presentation forms can be easily realized, preferably in tablet form or especially in spherical form, which have laundry after-treatment character. A preferred embodiment of the invention is therefore illustrated by laundry after-treatment agents that comprise the inventive scent composites which include suitable ingredients for laundry after-treatment, preferably those with softening properties, wherein these ingredients are advantageously comprised in amounts of less than 60 wt. %, very advantageously less than 50 wt. %, extremely advantageously less than 40 wt. %, even more advantageously in amounts of less than 30 wt. %, and especially in amounts of less than 20 wt. %, based on the scent composite. These agents in turn are obtained by heating the original scent composites until they are converted to the liquid state, and then suspending therein the additional ingredients. Alternatively, the additional ingredients can also be directly suspended therein when a scent composite is being manufactured, advantageously when the scent composite is in the heated liquid state. On allowing the mixture to cool, one then obtains the laundry after-treatment agent.

A preferred embodiment is constituted by single portions of laundry after-treatment agents, preferably in tablet form and/or in spherical form, which essentially consist of a solid inventive scent composite, wherein the scent composite includes one or a plurality of suitable ingredients for laundry after-treatment, preferably softening ingredients. These softening ingredients are particularly combinations of clays, preferably bentonite, with pentaerythrol or pentaerythrol derivatives.

The advantage of such presentation forms, which according to a preferred embodiment can be dosed via the wash cabinet and/or directly in the wash drum, is obvious. The consumer receives a single portion of a laundry after-treatment agent, meaning that he can avoid the tedious step of dosing the laundry after-treatment agent. The consumer can immediately smell the type of fragrance that the washing will have after the washing process. The consumer gets a long-lasting fragrant experience and after the washing process, pleasant smelling and softened washing.

In a preferred embodiment, the comprised scent composite is not present in the form of compounds with other detergent or cleanser ingredients, but rather in the form of separate solid particles, preferably spherical particles, and particularly preferably colored particles.

A further subject of the invention is in the use of the scent composite for perfuming rooms, automobiles or cupboards, especially in the form of scent stones and/or small scent bags that can be single-colored or multi-colored in design.

A further subject of the invention is illustrated by the use of the inventive scent composites for perfuming objects, preferably detergents, washing and cleaning machines, dry washing and laundry and packaging. For this, the perfuming is achieved, for example, by placing appropriate scent composites in the proximity of the objects to be perfumed, for example, washing. Packaging can be perfumed by spraying, for example, with a scent composite, as described above.

The use of the inventive scent composites for perfuming textiles during the preferably automatic washing or drying process illustrates a further subject of the invention.

As noted above, a further advantage of the scent composites, particularly the solid scent composites, is that they can be easily liquefied and easily molded into shapes. Accordingly, a product that is obtained by filling a hollow mold with an inventive scent composite at temperatures at which the scent composite is free flowing, and wherein the scent composite is allowed to solidify in the mold by cooling, illustrates a further subject of the invention. According to a preferred embodiment, this mold is insoluble in water.

On the other hand, however, it can also be advantageous that the mold does dissolve in water, for example, when such a product is employed in an automatic washing process. Accordingly, according to a further preferred embodiment, the mold is characterized in that it completely dissolves under the washing conditions, wherein the mold consists especially of natural and/or synthetic polymers or urea (derivatives) and polyethylene glycol. According to a preferred embodiment, the mold is of a spherical design, especially shaped like a ball.

A further subject of the invention is the use of the inventive scent composites for the controlled long-lasting release of pheromones. Pheromones are essentially signaling substances, released by a species and which trigger specific reactions particularly with members of the same species. Here, extremely low concentrations that are preferably below the human smell-detection limits are also sufficient to elicit a specific reaction from addressees. Such pheromones can be attractants, for example.

In particular, scent composites that serve as attractants are suitable here, the composite either being characterized by an increased adhesiveness, or in that it also contains insecticides, preferably on the surface. In such a case, the insect is attracted by the attractant that is slowly and continuously released from the scent composite. It then either remains stuck to the composite and perishes there, or it is killed by the applied insecticide. Consequently, a preferred embodiment concerns the use of inventive scent composites for the controlled, long-lasting release of pheromones, with the proviso that the pheromones are insect attractants and the scent composite contains insecticides. A further subject of the invention is the use of the inventive scent composites for the controlled, long-lasting release of odoriferous substances with insect repelling activity (repellents). This is a very advantageous field of application, because the release of such insect repellent odoriferous substances, already in extremely low concentrations, has a significant effect on insects. Therefore a very long-lasting defense against insects can be achieved by the use of small amounts of active odoriferous agents.

### EXAMPLES

The perfume oil M1 used in examples 1, 3 and 4 is a lily of the valley composition having the following composition:

lilial 15.0 wt. %, lyral 20.0 wt. %, citronellol 10.0 wt. %, phenylethyl alcohol 10.0 wt. %, alpha-hexylcinnamaldehyde 10.0 wt. %, geraniol 5.0 wt. %, benzylacetone 3.0 wt. %, cyclamenaldehyde 2.0 wt. %, linalool 2.0 wt. %, boisambrene forte 1.7 wt. %, ambroxan 0.2 wt. %, indole 0.1 wt. %, hedione 16.0 wt. %, sandelice 5.0 wt. %.

### Example 1

Preparation of 100 G Solid Perfume Oil-Scent Composite

33.33 g hexadecanol (m.pt. 49.6° C.) were added to 66.66 g of liquid perfume oil M1 and heated with stirring to about 52° C., i.e. until a clear solution was obtained. The mixture solidified on cooling. The amorphous mass was completely solid at temperatures below 30° C.

### Example 2

Preparation of 100 G Solid Geraniol-Scent Composite

a) A mixture of 30 g decanoic acid (melting point 31.5° C.) and 30 g hexadecanol (melting point 49.6° C.) was added to 40 g of a liquid odoriferous substance from the group of the terpene alcohols (geraniol) and heated with stirring to 50° C. A solid mass was obtained after cooling to 23° C.
b) 40 g geraniol was mixed with 60 g dodecanoic acid (melting point 43.5° C.) and heated to 45° C. The mixture solidified after cooling to 25° C.

### Example 3

Preparation of 100 G Solid Perfume Oil-Scent Composite

For long-lasting perfuming of detergents, 10 g Dehydol® (tallow fat alcohol with 5 ethoxy units, pour point ca. 36° C., Cognis GmbH Germany) as well as 35 g octadecanol (melting point 57.9° C.) were added to 55 g liquid perfume oil M1 with stirring and briefly heated. The clear solution could be sprayed at 55° C. like any other liquid on detergent ingredients in the Lödige Mixer. The mixture was solid after cooling to ca. 25° C.

### Examples 4 and 5

Preparation of 100 G Solid Perfume Oil-Scent Composite and Solid Oil of Rosemary-Scent Composite.

Both experiments were run in parallel and with the same quantities. 30.0 g octadecanol was added with stirring to 70 g of the liquid perfume oil M1 in glass beaker 1 and to 70.0 g oil of rosemary in glass beaker 2, respectively and briefly heated to afford clear solutions (ca. 59° C.). Both mixtures solidified after cooling to 25° C. The highly viscous phase was filtered very quickly.

1. A scent composite composition comprising at least one perfume oil and at least one additive that is flowable at increased temperatures and which has a melting point or pour point in the range of 20° C. to 100° C., wherein said composition is highly viscous or solid at 18° C. and below and forms a molten liquid at temperatures below 110° C., without substantial decomposition.

2. The composition according to claim 1, wherein said composition comprises at least 20 wt. % perfume oil.

3. The composition according to claim 1, wherein said composition is highly viscous or solid at up to 40° C.

4. The composition according to claim 1, wherein said composition comprises up to 90 wt. % of the at least one additive with melting point or pour point between 20° C. and 100° C. based on the total composition.

5. The composition according to claim 1, wherein said composition comprises less than 10 wt. % water.

6. The composition according to claim 1, wherein the at least one additive having pour points in the range of 20° C. to 100° C. is selected from the group consisting of fatty alcohols, fatty acids, silicone oils, paraffins, nonionic surfactants, esterquats, natural oils, waxes and polyalkylene glycols.

7. The composition according to claim 1, wherein said composition additionally comprises detergent solids.

8. The composition according to claim 7, wherein the content of the detergent solids is less than 70% based on the composition.

9. The composition according to claim 7, wherein the detergent solids have a D₅₀-value of less than 0.2 mm.

10. The composition according to claim 7, wherein said composition further comprises ingredients selected from the group consisting of zeolites, bentonites, silicates, phosphates, urea, urea derivatives, sulfates, carbonates, citrates, citric acid, acetates and or salts of anionic surfactants.

11. A process for solidifying perfume oil, said process comprising the step of combining conventional perfume oils with additives that are at least partially soluble in the perfume oil and have a pour point of from 20° C. to 100° C. to produce the solidified perfume oil, which is highly viscous or solid at temperatures up to 18° C. and forms a molten liquid at temperatures below 110° C. without substantial decomposition.

12. The process according to claim 11, comprising the steps of
a) blending one or more perfume oils at 20° C. to 22° C., with stirring, with the additives,
b) heating the mixture to temperatures above the pour point of the additives,
c) maintaining the increased temperature, and
d) cooling the mixture to a temperature of 18° C. to 25° C. to produce a solid.

13. The process according to claim 12, wherein the mixture is sprayed, prilled or made into pastilles prior to cooling step d), thereby forming fine droplets, beads, prills or pastilles.

14. The process according to claim 11, comprising the steps of adding the mixture of perfume oil(s) and additives to liquid carbon dioxide, blending the mixture in liquid carbon dioxide and spraying the resulting blend.

15. A detergent or cleanser comprising the scent composite composition according to claim 1.

16. The detergent or cleanser according to claim 15, wherein the scent composite composition is in the form of separate solid particles.

17. A laundry after-treatment agent comprising the scent composite composition of claim 1 and a fabric softener, wherein the fabric softener comprises less than 60 wt. % based on the scent composite composition.

18. The composition according to claim 17, wherein said laundry after-treatment agent comprises combinations of clays with pentaerythrol or pentaerythrol derivatives.

19. The composition according to claim 17, wherein said composition is present in tablet form.

20. A process for perfuming textiles, said process comprising the step of applying to the textiles during the washing and drying process the scent composite composition of claim 1.
